(19) United States
(12) Patent Application Publication
(10) Pub. No.: US 2026/0163224 A1
(43) Pub. Date: Jun. 11, 2026

(54) METHOD FOR SMOOTHING THE INNER SIDE OF A HIGH-FREQUENCY WAVEGUIDE

(71) Applicant: FRIEDRICH-ALEXANDER-UNIVERSITÄT ERLANGEN-NÜRNBERG, Erlangen (DE)

(72) Inventors: Florian HUBERT, Höchstadt / Aisch (DE); Andreas HOFMANN, Erlangen (DE); Mark SIPPEL, Fürth (DE); Konstantin LOMAKIN, Nürnberg (DE); Gerald GOLD, Erlangen (DE)

(21) Appl. No.: 18/707,544

(22) PCT Filed: Nov. 2, 2022
(86) PCT No.: PCT/EP2022/080575

§ 371 Date: May 3, 2024

(30) Foreign Application Priority Data
Nov. 5, 2021 (DE) 10 2021 128 881.9

(51) Int. Cl. H01P 11/00

(52) U.S. Cl. CPC H01P 11/002

(57) ABSTRACT

The present invention relates to a method for smoothing the inner side of a high-frequency waveguide, wherein the waveguide has a main body with an outer side and with an inner side and wherein the main body contains one or more clearances, which extend between the outer side and the inner side, wherein the smoothing of the inner side of the waveguide is performed by means of a galvanic process in which a layer generated by the galvanic process is formed on the inner side of the waveguide and has the effect of smoothing the inner side of the waveguide.

The present invention relates to a method for smoothing the inner side or inner sides of a high-frequency waveguide, wherein the waveguide has a base body with an outer side and with an inner side and wherein there are one or more openings in the base body which extend between the outer side and the inner side.

In the context of the present invention, the term “high-frequency waveguide” is to be understood not only as a high-frequency waveguide as such, but also as any component and any system comprising one or more high-frequency waveguides manufactured according to the method of the invention. Examples include filters, couplers, resonators, antennas, etc. The term “high-frequency waveguide” is thus to be understood broadly.

It is known from the prior art to use waveguides for high-frequency technology, which are manufactured from metal by machining. The use of so-called split blocks is also known. These are waveguides that consist of several separately manufactured individual parts and are joined together precisely. This allows access to the inner sides for machining tools.

In the frequency range above 1 GHz, coaxial cables have disadvantages when transmitting high power, e.g. when transmitting broadcast signals such as high attenuation, which can lead to considerable losses. To avoid this and other disadvantages, so-called waveguides are used in radar systems, for example, to transmit high-power RF signals. Waveguides are usually metallic tubes. These can, for example, have a (usually) rectangular cross-section or other cross-sectional shapes, such as round or elliptical.

In addition to conductivity, the roughness of the conductive surface on the inner side of the waveguide is essential for the performance of high-frequency waveguides, especially at high frequencies, wherein a low roughness is generally aimed for in order to keep attenuation low.

In order to achieve this, it is known from the prior art to smoothen the inner side of the surface, e.g. by abrasion or chemically, e.g. by pickling. If this is done on surfaces that are already conductive or metallic, it is often accompanied by the creation of undesirable micro-roughness or a change in the geometry of the component. If this is done on surfaces that are not yet conductive, such as plastic surfaces, this smoothing can lead to adhesion problems for the subsequently applied conductive coating, so that the conductive coating flakes off or does not pass the cross-cut test or another adhesion test, for example.

Geometries produced using additive manufacturing provide the advantage that essentially any geometries can be produced, especially monolithically, i.e. in one part, which eliminates fitting problems during assembly/joining. However, mechanically stable 3D printing methods in particular, such as SLM (direct metal 3D printing), SLS (selective laser sintering based on plastics), (S)EBM ((selective) electron beam melting, fused deposition modeling) etc., result in very rough surfaces with RMS (root-mean-square) roughness of Rq>5 μm, which are accompanied with considerable performance losses.

Some of these processes or methods (SLM, (S)EBM) can produce metal components directly, which means that subsequent coatings are no longer required. Using stereolithographic methods, for example, it is possible to produce surfaces with roughness in the range of Rq less than or equal to 1 μm. With conventional methods (e.g. composite split blocks), however, values of 200-600 nm can be achieved with the corresponding manufacturing effort.

Against this background, the present invention is based on the object of further developing a method of the type mentioned above in such a way that the inner side of the waveguide is mechanically stable and has a very low roughness and thus offers very good performance in RF applications.

This object is achieved by means of a method having the features of claim 1.

Accordingly, it is provided that the smoothing of the inner side of the waveguide takes place by means of a galvanic process, in which a conductive/metallic layer produced by the galvanic process is formed on the inner side of the waveguide, by means of which the inner side of the waveguide is smoothed. The surface of the inner side of the waveguide is thus formed (partially or completely) by the galvanically applied (smooth) coating.

The layer produced in this way is a metallic, electrically-conductive layer.

In the context of the present invention, “conductive” is to be understood as “electrically conductive”.

Smoothing of the inner side of the waveguide“ means that the roughness of the surface of the inner side of the waveguide is less after application of the method according to the invention than before.

The “inner side of the waveguide” can be understood to mean its entire inner side or its surface, or only a partial area thereof. Both are covered by the present invention.

The method according to the invention achieves galvanic smoothing, which is the removal of unevenness. This includes both the removal of coarse unevenness and low-lying areas of the surface (leveling) and the removal of micro-roughness on the outermost areas of the surface. The effect of micro-roughness in HF measurements is such that a surface with many low-lying areas still delivers reasonable performance due to the relatively smooth uppermost areas.

As a result, significantly better HF characteristics can be achieved than with conventional production, which can only be physically explained by an improved surface quality.

The method provides the advantage that base bodies can also be used which have a rough inner side after their manufacture, such as base bodies which are manufactured using a 3D printing method, such as SLS (selective laser sintering) or SLM (selective laser melting). The method according to the invention subjects these rough inner sides to a smoothing method, which means that base bodies produced using a 3D printing method or another additive method also have excellent HF characteristics after treatment with the method according to the invention. It is also conceivable that the base body was produced using conventional manufacturing methods (machining methods, composite split blocks, injection molding, spark erosion, etc.) and is smoothed using the method according to the invention.

This means that stable, industrial 3D printing methods (e.g. SLS, SLM, fused deposition modeling (FDM), SLS-FDR (fine detail resolution)) can now be used without having to accept a technical disadvantage from the very rough surface inherent in the method. With the method according to the invention, this can be “smoothed” back to a very high performance. This allows the surface profile to be influenced/modified in such a way that an RF performance similar to that of an originally very smooth surface is achieved.

The advantage of a rough surface of the base body is the good adhesion of the electroplated layer, the electroplated smoothing leads to a HF performance as with an originally very smooth surface of the base body.

The adhesion problem described at the beginning is now not a problem since the rough surface of the base body is positive for the adhesion of the applied layer or the applied layer system and since its roughness does not play a role for the final waveguide, since the roughness is completely eliminated or at least reduced by the galvanic smoothing.

It is preferable to use base bodies that only have conductive structures at the points where HF functionality is required.

Preferably, base bodies are used that also or exclusively have slots as openings.

The openings in the base body facilitate electroplating on the inner side of the base body.

It is conceivable if the base body is constructed according to the mechanical and electrical function (mechanical function=supports). Electrically, openings are preferably made according to the field distribution of the subsequent application so that this is not or only slightly impaired.

However, the invention also includes other openings, such as circular, elliptical openings, etc. Preferably, a plurality of slots are used, in particular or exclusively in the side walls, i.e. lateral surfaces of the waveguide. In the context of the present invention, the slots (or other openings) explicitly fulfill the purpose of facilitating the smoothing of the preferably conductive inner sides of the hollow body by means of galvanic processes.

It is particularly advantageous if the galvanic process is based on a one-piece waveguide. At the moment in which the base body is exposed to the galvanic process, it is therefore preferably one-piece or monolithic. The slotted waveguides, for example, are primarily subjected to the method as monoliths (i.e. not a classic split block) and do not require any special positioning of the at least one electrode for good results.

Preferably, the inner side of the waveguide is not subjected to a smoothing method before the electroplated layer is applied, which simplifies production accordingly. As explained above, a rough surface on the inner side of the waveguide or the base body is particularly positive in order to ensure good adhesion of the (galvanically) applied individual layer or the (galvanically) applied layer system.

It is conceivable that the (at least one) electrode for carrying out the galvanic process is attached to the outer side of the waveguide, which simplifies the method in that there is no need to position the electrode on the inner side, which may be difficult to access.

As mentioned above, a waveguide or hollow body produced by means of an additive method, in particular by means of a 3D printing method, can be used as the base body. However, the invention is not limited to the use of such base bodies.

The method can ensure very high HF performance without having an already smooth original surface of the base body.

Preferably, a waveguide with an inner side that is electrically conductive before the galvanic process is used as the base body. However, the invention also includes base bodies with a non-electrically conductive inner side.

By using the method according to the invention, poorly conductive but, for example, more (corrosion) resistant metals, such as nickel, zinc or chromium, can also be used, wherein the galvanic smoothing nevertheless enables a high, or at least acceptable, HF performance at high frequencies. This is due to the fact that at high frequencies the surface quality is decisive compared to the DC conductivity and this is only explicitly aimed for and made possible with the method according to the invention.

The cross-sectional dimensions of waveguides depend on the intended frequency range. The higher this is aimed for, the smaller the cross-sectional dimensions must be. At the same time, the layer thickness plays a lesser role and the surface roughness a much greater one.

It is particularly advantageous if the area-related current used in the galvanic process is set as a function of the specified frequency range-and thus in conjunction with the cross-sectional dimensions of the waveguide. For example, to achieve particularly good performance, it is conceivable that the galvanic coating is performed at an area-related current of ≤0.1 nA/mm² component surface, preferably ≤0.05nA/mm².

For example, it is conceivable to coat a component surface in a frequency band (in which the HF waveguide is used) of 60-90 GHz with an area-related current of ≤0.1 mA/mm², especially in the galvanic process in acidic copper electrolytes.

For frequencies below 50 GHz, it is conceivable to use the same electrolyte (acidic copper electrolyte) with I≤1 mA/mm² to accelerate the process.

At frequencies above 100 GHz, for example, area-related currents of I≤0.05 mA/mm² can be advantageous in order to achieve a particularly good surface quality, e.g. with acidic copper electrolyte in the galvanic bath.

In acidic nickel electrolytes in the galvanic bath, a similar pattern results for the area-related currents, i.e. the above values apply accordingly.

In the case of gold or zinc electrolytes, it may be advantageous to halve the current ranges specified above for the respective frequency range.

At higher frequencies, a “smoother” surface is always required, which is mainly achieved by a lower coating current.

An “area-related current” is the current per surface area of the base body.

If necessary, the low area-related current and the associated slow build-up of the electroplated layer can be compensated for by “compensating” the layer thickness with a longer method duration. For example, an electroplating time of t>5 min at I≤0.1 mA per mm² base body surface is conceivable. For particularly rough base surfaces, it is conceivable to select a method duration significantly longer than 15 minutes at the aforementioned low current.

It may be provided that the higher the predetermined, i.e. desired, frequency range in which the RF component coated using the method according to the invention is used, the lower the current is set. Depending on the desired frequency range, an increase in performance—optimized for this frequency range—can thus be achieved by adjusting the method parameters in accordance with the invention.

In this embodiment of the invention, this means, by way of example, that at very high frequencies (>100 GHz) a significantly lower area-related current is used for the coating than is the case for frequencies in the lower range (e.g. <50 GHZ).

Preferably, the area-related current used in the galvanic processes is in a range of I≤0.1 mA/mm² or in a range of I ≤0.05mA/mm².

For example, it is conceivable to use an area-related current of ≤0.1 mA per mm² component surface for the 60-90 GHz application range with a Cu electrolyte, i.e. with a galvanic bath containing Cu ions.

In one embodiment of the invention, bright electrolytes such as a Cu bright electrolyte, tin bright electrolyte, zinc bright electrolyte, gold bright electrolyte or a Ni bright electrolyte are used in the galvanic process in the galvanic bath.

It is conceivable that the galvanic bath contains one or more of the metals zinc, chromium, nickel or tin or their ions. This means that electrolytes and deposition materials can be used that have poorer DC conductivity but other properties, such as corrosion resistance, chemical resistance or scratch resistance.

With the present method, these materials can be made so smooth that good HF performance is still achieved. This refers in particular to metals such as zinc, chromium, tin and nickel.

It is conceivable that, depending on the requirements and application, metals are used in the galvanic process so that the electroplated layer contains or consists of one or more of the metals gold, copper, silver, aluminum, iridium, nickel, palladium, rhodium, zinc, tin, chromium.

The invention also includes the combination of different layers to produce a layer sequence/or a layer system on the inner sides of the waveguide, which has specific technical advantages (diffusion barriers, passivation, corrosion protection, adhesion promotion, etc.).

In one embodiment of the invention, it is provided that the inner side of the waveguide is roughened before the galvanic process is applied.

The base body can be a preferably monolithic waveguide, in particular a slotted waveguide, which is only slotted on its narrow sides. This means that a waveguide with a fairly rectangular cross-section has four side walls that surround the cavity. Due to the rectangular shape, two sides, namely the aforementioned narrow sides, have a smaller surface area than the other two side walls.

It is conceivable that the base body already has a conductive surface before the electroplated coating is applied to it. This is not mandatory. The invention also covers the electroplating of a non-conductive surface.

The invention covers both the case in which an already electrically conductive base body is used, e.g. a base body made of metal, which is produced for example by SLM or an EBM process, as well as the case in which a non-electrically conductive base body is used. This can, for example, be provided with a conductive coating (e.g.: electrolessly deposited or also using the “nano-ink process”) before it is subjected to the method according to the invention.

In one embodiment, the base body is manufactured using an additive method that processes conductive materials, such as selective laser melting (SLM) or electron beam melting (EBM).

The base body can be manufactured using an additive method that produces relatively smooth plastic surfaces, such as SLA.

In one conceivable embodiment of the invention, the base body is roughened using a pre-treatment method for the purpose of improving adhesion and then smoothed by electroplating using the present method. The initial deterioration of the surface for the purpose of adhesion promotion is thus “revised” by the method.

The invention also relates to a high-frequency waveguide whose inner side is smoothed according to a method according to any one of claims 1 to 13. The waveguide can have the features of one of claims 1 to 13, e.g. be designed as a monolith, etc.

As already explained at the beginning, the term “high-frequency waveguide” is to be understood broadly and includes a high-frequency waveguide as such, as well as a high-frequency waveguide component or a high-frequency waveguide system. Examples include antennas, couplers, etc. Thus, the invention also relates to high-frequency components and systems and their manufacture, which comprise at least one waveguide manufactured according to claims 1 to 13 or are based on waveguide technology and have been galvanically smoothed using the method according to the invention.

The RF waveguide produced according to the invention can have a single or multi-layer system. This may, for example, consist of the sequence copper-nickel, copper-nickel-gold, copper-nickel-zinc, copper-nickel-tin, copper-nickel-chromium, silver-gold, nickel-silver, nickel-silver-gold, copper-silver or copper-silver-gold or have one or more of the said coatings, the layers having been deposited by a method according to claims 1 to 13. Such a multilayer system can be advantageously used in particular for the purpose of passivation/increasing resistance, etc.

Advantageously, the method according to the invention leads to a reduction of the surface impedance in the application frequency range and/or to a reduction of the conductor losses in the application range.

It is particularly advantageous to carry out the method in such a way that the load-bearing curve of the surface profile is changed in such a way that the surface impedance is reduced in the relevant frequency range.

It is conceivable that the method is performed in such a way that the final surface quality of the inner side of the waveguide of effectively Rq≤600 nm, preferably Rq≤400 nm, is achieved. This refers to the part of the load-bearing curve that is relevant for the electromagnetic wave, i.e. the effective roughness value.

In a preferred, non-limiting embodiment of the invention, the core of the invention consists in the use of galvanic processes with the explicit aim of smoothing or producing extremely smooth and/or leveling conductive surfaces on the inner sides of slotted waveguides on existing, sometimes very rough, conductive surfaces (base surface/initial surface) of the base body.

At this point, it should be noted that the terms “one” and “one” do not necessarily refer to exactly one of the elements, although this is one possible version, but can also refer to a plurality of the elements. Similarly, the use of the plural also includes the presence of the element in question in the singular and, conversely, the singular also includes several of the elements in question.

Further details and advantages of the invention are explained in more detail with reference to an exemplary embodiment shown in the drawing.

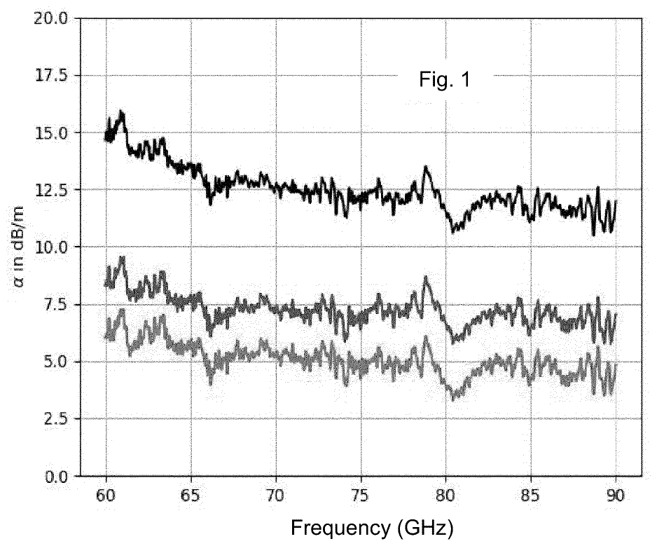

FIG. 1 shows the attenuation a as a function of frequency for base bodies coated according to the method for different coating durations using the galvanic process in an acidic copper electrolyte.

The base body consists of a hollow body manufactured using SLS, which has a high surface roughness per se.

The top line shows the damping properties after a comparatively short galvanic coating of this base body according to the invention, the middle line for a comparatively longer galvanic coating and the bottom line the damping properties for a base body that has been subjected to an even longer galvanic coating according to the invention.

As is readily apparent from the figure, the high-frequency waveguide produced according to the invention achieves excellent, low attenuation properties, which is due to an extremely smooth coating on the inner side of the waveguide, which was achieved by means of the metallic galvanic coating.

However, it is also possible to achieve relatively smooth surfaces, such as those deposited by wet chemical deposition, using the method described above by galvanically smoothing the internal surfaces.

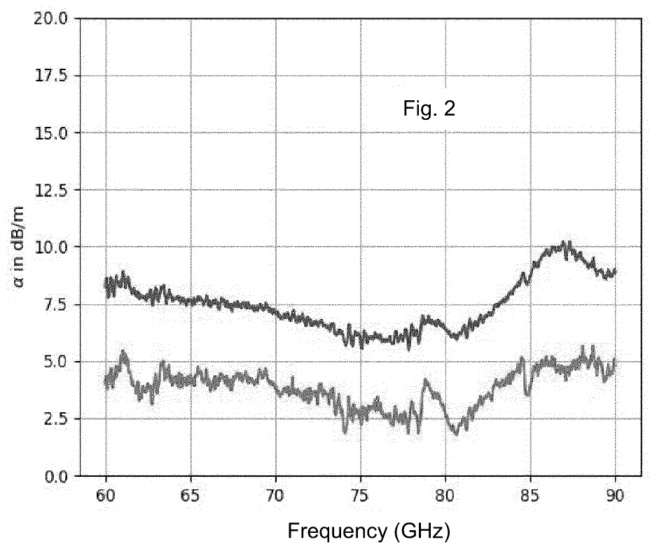

This is shown in FIG. 2. Here, the insertion loss of the wet-chemically coated slotted waveguide before application of the method according to the invention is first plotted as the upper curve of the attenuation a as a function of the frequency.

After carrying out the method according to the invention in an acidic copper electrolyte, a significantly improved HF performance is achieved despite the already relatively smooth surfaces (lower insertion loss), which in turn is a result of the improved surface quality achieved by the method. This is shown in the form of the lower curve in FIG. 2.

1. Method for smoothing the inner side of a high-frequency waveguide, wherein the waveguide comprises a base body with an outer side and with an inner side and wherein one or more openings are located in the base body which extend between the outer side and the inner side, wherein the smoothing of the inner side of the waveguide is performed by means of a galvanic process, in which a conductive metallic layer produced by the galvanic process is formed on the inner side of the waveguide, by means of which smoothing the inner side of the waveguide is performed.

2. Method according to claim 1, wherein the openings are slots.

3. Method according to claim 1, wherein the galvanic process is based on a waveguide as a one-piece base body.

4. Method according to claim 1, wherein the inner side of the waveguide is not subjected to a smoothing method before the galvanic layer.

5. Method according to claim 1, wherein the electrode(s) for carrying out the galvanic process is/are mounted on the outer side of the waveguide.

6. Method according to claim 1, wherein a base body produced by means of an additive method, in particular by means of a 3D printing method, is used as the base body.

7. Method according to claim 1, wherein a waveguide with an inner side which is electrically conductive before the galvanic process or has a coating which is electrically conductive is used as the base body.

8. Method according to claim 1, wherein the area-related current used in the galvanic process is adapted or selected as a function of the intended application frequency range of the waveguide.

9. Method according to claim 8, wherein the higher the predetermined frequency range, the lower the area-related current is set.

10. Method according to claim 8, wherein the current used in the galvanic processes, related to the surface of the component to be smoothed, is in a range of less than or equal to 0.1mA/mm²,

11. Method according to claim 1, wherein bright electrolytes are used in the galvanic bath in the galvanic process.

12. Method according to claim 11, wherein metals or the electrolytes required for the respective metal deposition are used in the galvanic process, so that the galvanically produced layer contains or consists of one or more of the metals gold, copper, silver, aluminum, iridium, nickel, palladium, rhodium, zinc, tin, chromium.

13. Method according to claim 1, wherein the inner side of the waveguide is roughened before the galvanic process is applied.

14. High-frequency waveguide, wherein its inner side is smoothed in accordance with a method according to claim 1.

15. High-frequency waveguide according to claim 14, wherein the high-frequency waveguide is a high-frequency waveguide per se, a high-frequency waveguide component or a high-frequency waveguide system.

16. High-frequency waveguide according to claim 14 wherein the waveguide comprises a layer system consisting in particular of the sequence copper-nickel, copper-zinc, copper-tin, copper-chromium, copper-nickel-silver, copper-nickel-gold, copper-nickel-zinc, copper-nickel-tin, copper-nickel-chromium, silver-gold, nickel-silver, nickel-silver-gold.
